(19) United States
(12) Patent Application Publication
(10) Pub. No.: US 2009/0055088 A1
(43) Pub. Date: Feb. 26, 2009

(54) SYSTEM AND METHOD OF PRIORITIZING TELEPHONY AND NAVIGATION FUNCTIONS

(75) Inventors: Harry Zhang, Chandler, AZ (US); Christopher S. Schreiner, Maricopa, AZ (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/844,168

(22) Filed: Aug. 23, 2007

(51) Int. Cl. G01C 21/00

(52) U.S. Cl. 701/201; 701/208

(57) ABSTRACT

A system is provided that includes a location determination element [230] to determine a current location of a mobile device [100] of a mobile subscriber. A map database [510] stores mapping information. At least one processor [200] (a) determines navigation directions from the current location to a destination location; (b) determines whether the current location is within a predetermined familiar area; and (c) prioritizes delivery of the navigation directions to the mobile device in response to the mobile subscriber being engaged in a communication via the mobile device at a time that the navigation directions are determined. Only a first type of the navigation directions are provided when the current location is within the predetermined familiar area. At least a second type of navigation directions, different from the first type, are provided when the current location is outside of the predetermined familiar area.

### TECHNICAL FIELD

This invention relates generally to a system and method for providing navigation directions to a user of a mobile device.

### BACKGROUND

Cellular phones are increasingly becoming the hub for telecommunication, information, entertainment, and news. In addition to traditional functions of receiving and making phone calls, many cell phones are equipped with navigation units using built-in Global Positioning System (“GPS”) modules or separate GPS modules that are connected with the cellular phones. Cellular phones can also be wirelessly connected to the Internet to acquire the latest news, music, and video broadcast.

A server-based navigation system has been proposed in the current art. Such a navigation system consists of a mobile navigation unit that transmits time and location (e.g., current and destination locations) information and a service center that receives the time and location information, selects a route between current and destination locations, and generates warning points and instruction points along the selected route. A voice or text message (e.g., “please turn right”) may be delivered to users over a mobile navigation unit or a cellular phone that is equipped with a navigation unit.

Other proposed systems in the art include a telephone handset used as an information system to provide navigation service and other services. Such a system includes a GPS unit in a mobile telephone and a remote map database server. A method of modifying information delivery to users when a conflict between a navigation unit and an in-vehicle roadside information center has also been proposed. The in-vehicle roadside information center may provide traffic count, traffic movement information, road condition warnings, intersection collision avoidance information, rollover warnings, and similar information.

When both navigation and telephony functions are available in a mobile telephone handset, it is possible that navigation directions (e.g., “turn left in a quarter of a mile”) are to be delivered to a telephone user while the user is conversing on the telephone. The navigation directions may be a text message, voice message, a visual icon, or a combination of these. At present, navigation direction messages are delivered in the same manner regardless of whether the user is currently conversing on the telephone. For example, if visual icons and voice messages are used for navigation directions, both of them will be delivered every time a particular maneuver (e.g., a left turn) is required. Voice messages may be effective in getting the user's attention when the user is not conversing on the telephone, but may be ineffective and also annoying to the user when the user is conversing on the telephone.

Furthermore, the delivery of navigation messages is not based on context at present. Little effort has been made in current systems in use to distinguish between a situation in which the user urgently needs navigation directions for getting from location A to location B, and another situation in which the user may only need to confirm the route periodically.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates a mobile device according to at least one embodiment of the invention;

FIG. 2 illustrates various components of the mobile device according to at least one embodiment of the invention;

FIG. 3 illustrates a method of delivering navigation messages according to at least one embodiment of the invention;

FIG. 4 illustrates a method of determining the user's home location according to at least one embodiment of the invention; and

FIG. 5 illustrates a system for communication between a mobile device and a remote server according to at least one embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments of the present invention. Also, common and well-understood elements that are useful or necessary in a commercially feasible embodiment are often not depicted in order to facilitate a less obstructed view of these various embodiments of the present invention.

### DETAILED DESCRIPTION

Generally speaking, pursuant to these various embodiments, a method and system is provided for prioritizing the delivery of navigation directions to a user of a mobile device or some other type of telephone handset, such as a Personal Digital Assistant (“PDA”). When a user is traveling to a location and needs navigation directions, the user can provide the location to the mobile device. For example, the user can manually enter the destination location via alphanumeric keys or buttons on the casing of the mobile device. Alternatively, the mobile device may have a Bluetooth, Universal Serial Bus (“USB”), Infrared (“IR”), serial cable, or any other type of suitable communication reception element to receive the location from another electronic device. In some embodiments, the user may enter the location via a keyboard or keypad of a personal computer and the location information may be transmitted from the personal computer to the mobile device. The location information may alternatively be sent to a remote server for processing.

Once the final destination is known, directions are determined from the mobile device's current location to the destination location. The current location may be determined based on GPS information for the mobile device. For example, the mobile device may include a GPS communication device for determining the GPS coordinates for the mobile device. Alternatively, a separate GPS device may be connected to the mobile device to provide the GPS coordinates to the mobile device.

In embodiments in which the final destination is provided ahead of the time at which the user is going to travel, the user may enter a code or undertake some other designated action to cause the directions to be determined at a later time. In some embodiments, a remote server includes a database of mapping information. The remote server determines the directions based on the mapping information in the database. Alternatively, the mobile device itself may include the mapping information for determining the navigation directions.

The teachings discussed herein provide a prioritization method for providing the directions to the mobile device. One or more “home locations” are determined for the mobile device. The home locations may be determined by recording GPS coordinates for the mobile device over a period of time when the mobile device is likely to be within a familiar area. For example, the GPS coordinates may be recorded in the middle of the night, when the user is likely at home asleep and the mobile device is likely at home with the user. The GPS coordinates may also be recorded during the daytime hours when the user is likely at work. Over a period of time such as, for example, a 30-day period of time, the GPS coordinates can be analyzed for patterns. If a large percentage of the GPS coordinates within certain measuring intervals are in approximately the same location, such GPS coordinates may be determined to correspond to a home location.

The GPS coordinates may also be recorded in response to a prompting by the user. For example, the user might enter a code to cause the mobile device to determine the present GPS coordinates for the mobile device and may use those coordinates as a home location.

The identities of the home locations are utilized to assist in prioritizing the delivery of navigation directions. In the event that the user is not using the mobile device at the time that navigation directions are to be sent to the mobile device, both audible and visual navigation directions are provided to the mobile device. The audible navigation instructions may include, for example, an audio voice instructing the user to “turn left at Main Street,” or “Exit Highway 210 at Exit Number 87.” The visual navigation instructions may include, for example, an arrow displayed on a display screen of the mobile device instructing the user as to which direction to turn and how much farther to travel.

In the event that the user is in the process of engaging in a conversation via the mobile device at the time that the navigation directions are to be provided, the navigation directions are prioritized. If the user is within a certain range of a home location, such as 10 miles, for example, only visual navigation directions are provided to the mobile device. Because the user is close to the home location, it is likely that the user is generally familiar with the local area, and therefore, the user's current conversation on the mobile device will not be interrupted. On the other hand, if the user is located beyond a certain range from a home location, it becomes more likely that the user is not familiar with the user's location. Accordingly, the user's conversation will be interrupted to deliver both audible and visual navigation directions. The user's current location may be periodically updated such as, for example, every second to determine whether the user is within the designated distance from one of the home locations. The priority of the delivery of the navigation directions may be changed periodically as the user travels between home locations and unfamiliar areas. The prioritization/conflict resolution method helps minimize driver distraction or confusion while continuing to assure the delivery of needed and useful information.

The delivery of navigation messages is based on whether the user is traveling in a familiar area (e.g., the user's home or locations that the user frequently travels to) and whether the navigations directions are absolutely necessary for getting from location A to location B. If the distance between the current location and the user's home is within a particular threshold (e.g., 10 miles), the user is traveling near a familiar area and does not necessarily rely on navigation directions for every maneuver. The user will likely have a good idea of streets and landmarks within a small radius from his/her home and may only want to confirm his/her travel plan using navigation directions periodically. If the user is conversing on the phone, only a visual icon (e.g., a left turn arrow) and a text message (e.g., a street name) are presented according to some embodiments. In this case, the telephony function has a higher priority than the navigation function. In order to ensure smooth continuation of a telephone conversation and minimize user annoyance, no voice navigation messages will be presented in some embodiments.

If the distance between the current location and the user's home exceeds the particular threshold distance discussed above, then the current latitude and longitude values acquired via GPS may be rounded to two decimal points (with a distance resolution of approximately one mile) and compared with the list of “frequently traveled” locations. If the current location is in the “frequently traveled” location list, then the user is determined to be traveling within a familiar location, and the telephony function has a higher priority than the navigation function. In this case, if the user is conversing on the phone, no voice navigation message will be presented, and only visual icons (e.g., a left turn arrow) and text messages (e.g., street names) will be presented.

If the current location is neither close to home nor in the “frequently traveled” location list, however, the user will be provided with navigation messages for getting from location A to location B. In this case, the navigation function has a higher priority than the telephony function. Even if the user is conversing on the phone, voice messages (e.g., a voice recording for “turn left ahead”) will be presented along with visual icons and text messages. In one embodiment, the phone conversation is not muted, and the user will be able to hear both the phone conversation and voice navigation messages. In another embodiment, the phone conversation is muted for a brief period of time (e.g., 5 seconds) while the voice navigation message is played. With the “mute” function, the user will be able to provide their undivided attention to navigation directions when the navigation message is played. This will minimize the likelihood of missing the voice navigation message. Because in this case the user needs navigation directions to reach his/her destination and expects to be guided by the navigation system, voice navigation messages are very useful and not as likely to be considered annoying or unwanted.

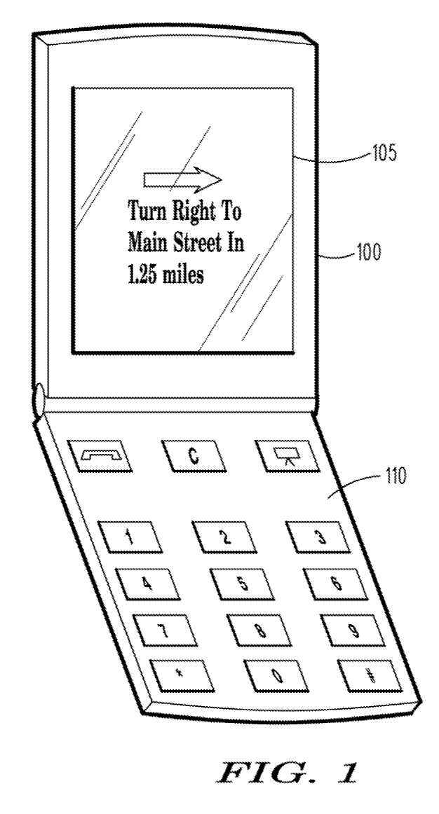

FIG. 1 illustrates a mobile device 100 according to at least one embodiment of the invention. As illustrated, the mobile device 100 includes a display 105, such as a Liquid Crystal Display (“LCD”), and an alphanumeric keypad 110. The mobile device 100 shown in FIG. 1 is a cellular telephone. However, it should be appreciated that other the teachings discussed herein are equally application to other electronic devices, such as a PDA or notebook computer.

As illustrated, the display 105 is utilized for displaying visual navigation directions to a user. In this case, a large arrow facing toward the right is shown, along with the text “Turn right onto Main Street in 1.25 miles.” Other visual indicia, such as flashing lights on the display 105 or elsewhere on the body of the mobile device 100 may also be utilized to indicate navigation directions to the user.

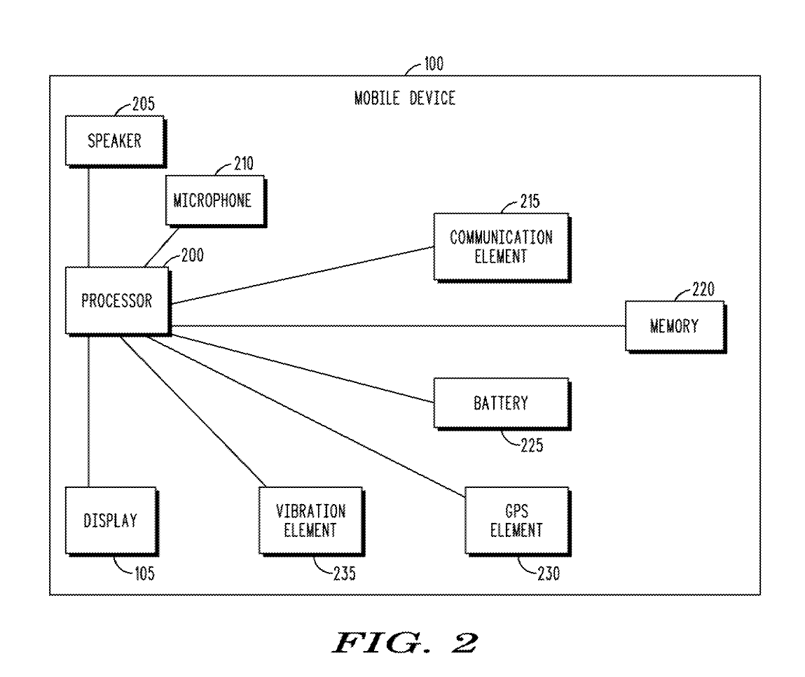

FIG. 2 illustrates various components of the mobile device 100 according to at least one embodiment of the invention. The mobile device 100 may include a processor 200 in communication with a speaker 205, a microphone 210, a communication element 215, a memory 220, a battery 225, a GPS element 230, a vibration element 235, and a display 105. It should be appreciated that in some embodiments, alternative and/or additional components may be included within the mobile device 100. The speaker 205 may be utilized to provide the audio navigation directions to the user, or to provide any other audio media, such as voice data during a phone call. The microphone 210 may receive audio information from the user such as, for example, when the user is talking to another party via the mobile device 100. The communication element 215 communicates with a server or other electronic device. The server may include a database of navigation directions. Alternatively, the navigation directions may be stored within the memory 220 of the mobile device.

The mobile device 100 may include a battery 225 to provide power to the various electronic circuitry/devices within the mobile device. The battery 225 may be rechargeable. The GPS element 230 provides GPS or other location information to the mobile device 100. The GPS element 230 may, for example, receive GPS coordinates from a GPS server or other device capable of determining GPS coordinates for the current location of the mobile device 100. In some embodiments, the GPS element 230 may not be included within the mobile device 100. In such embodiments, the GPS coordinates may instead be received from another device in communication with the mobile device 100. For example, an external GPS determining device may be coupled to the mobile device 100 to provide the GPS coordinates or other location information to the mobile device 100. In some embodiments, an external GPS determining device may wirelessly transmit the GPS coordinates to communication element of the mobile device 100 such as, for example, via an Infrared or Bluetooth transmission.

The mobile device 100 may include a vibration element 235 to indicate that the mobile device 100 has received a call or that navigation directions are ready for the user to view. In the event that the user is currently engaged in a telephone call via the mobile device 100 that has a higher priority than the delivery of navigation directions, only visual navigation directions are provided according to some embodiments. In such instances where only visual directions are provided, it may be necessary to alert the user that the navigation directions are ready to be viewed by signaling the user via the vibration element 235, for example. The display 105 may display textual directions or arrows, maps, or other indicia of direction. FIG. 1 illustrates textual and graphical directions displayed on the display 105 of the mobile device 100.

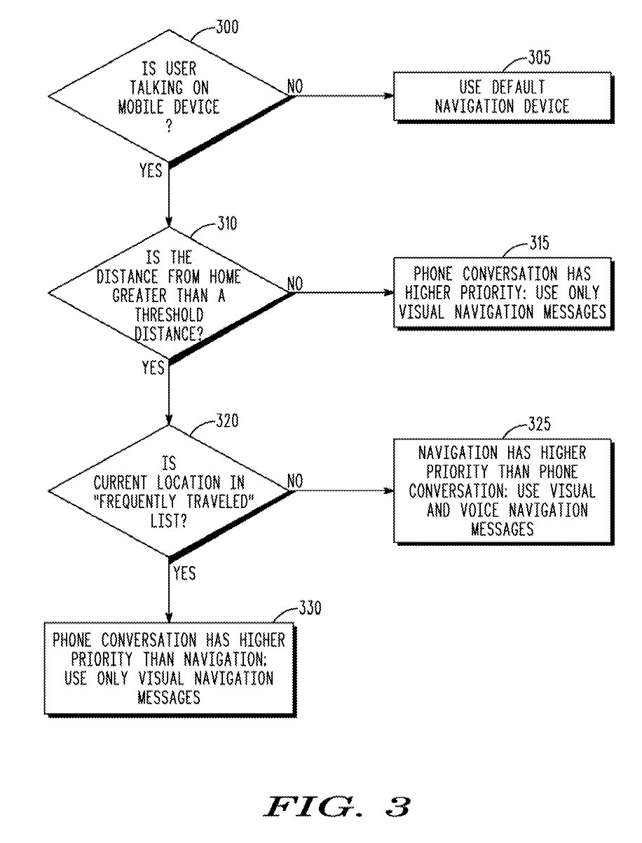

FIG. 3 illustrates a method of delivering navigation messages according to at least one embodiment of the invention. The method shown in FIG. 3 may be performed, for example, by the processor 200 of the mobile device 100. First, at operation 300, a determination is made as to whether the user is currently talking on the mobile device 100. If “no,” the default navigation settings are utilized at operation 305. The default navigation settings may include the delivery of both audio and visual navigation directions.

If “yes,” on the other hand, at operation 300, processing proceeds to operation 310 at which point a determination is made as to whether the distance between the user's current location (as determined by the location information for the mobile device 100) and one of the user's home locations is greater than a threshold distance such as, for example, 10 miles. If “no,” the phone conversation is provided the higher priority at operation 315, whereby only visual navigation messages are provided because the user is close to one of the user's home locations. If “yes,” on the other hand at operation 310, processing proceeds to operation 320 at which point a determination is made as to whether the user's current location is in a “frequently traveled” list, i.e., a list of locations that the user is known to frequent, and thereby with which the user is likely to be familiar. If “no,” processing proceeds to operation 325 at which point the navigation is provided the higher priority than the phone conversation and both the visual and voice navigation messages are provided to the mobile device 100. If “yes,” on the other hand, the phone conversation is provided a higher priority than the navigation instructions at operation 330 and only the visual navigation directions are provided to the user so that the user is not interrupted with audio navigation directions for an area in which the user is likely already familiar.

In the event that the navigation directions have a higher priority than the phone conversation, the audible navigation directions are provided at the same time that the user is engaged in the telephone conversation. In other embodiments, the phone conversation is muted for a brief period of time (e.g., 5 seconds) while the voice navigation message is played. With this “mute” function, the user will be able to offer their undivided attention to navigation directions when the navigation message is played. This will minimize the likelihood of missing the voice navigation message.

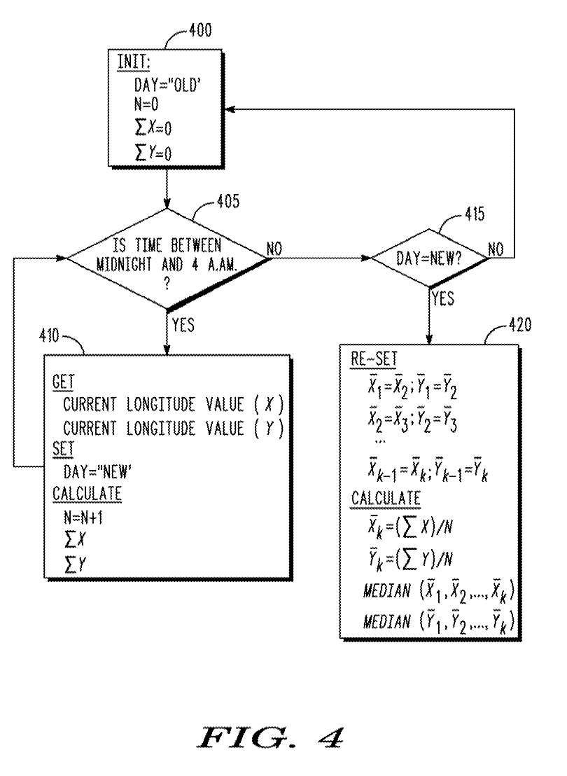

FIG. 4 illustrates a method of determining the user's home location according to at least one embodiment of the invention. First, at operation 400, various variables are initialized. The variable “Day” is initialized with the value “Old,” the counter N is initialized to 0, and (ΣX and ΣY) are each initialized to the value 0. Next, at operation 405, a determination is made as to whether the current time is between a particular time window (e.g., between midnight and 4 A.M.). This determination may be made by the processor 200 of the mobile device 100. If “yes,” then the current latitude and longitude values (e.g., X and Y) are acquired at operation 410. In some embodiments, the user can select the time at which such coordinates are acquired. Such coordinates are acquired because it is likely that the user is at home at this time. The “Day” variable is also set to “New,” the counter N is incremented, and (ΣX and ΣY) are computer with the newly acquired coordinates.

These values are summed over this time window (ΣX and ΣY), the number of latitude or longitude values within this time window is computed (N), and a “day” variable is set to “New.” If the GPS latitude and longitude information is sampled at 1 Hz, then the number of longitude and latitude pairs (N) will be 14,400 [4 (hours) by 60 (minutes/hour) by 60 (seconds/minute)].

If, at operation 405, a determination is made that the current time is beyond the particular time window, processing proceeds to operation 415, where a determination is made as to whether the “Day” variable is “New.” If “no,” processing proceeds to operation 400. If “yes,” on the other hand, then the mean latitude and longitude values for previous days are re-set at operation 420 to get ready for new calculation (e.g., assigning values at day K to values at day K−1 by Xₖ₋₁=Xₖ; Yₖ₋₁=Yₖ), and new calculations are performed for current day [e.g., Xₖ=(ΣX)/N; Yₖ=(ΣY)/N]. Finally, the median for all K days is computed [e.g., Median(X₁, X₂, . . . Xₖ)]. The home location is specified by the median latitude and median longitude values. The value for K may vary, but a preferred value may be 30 days so that the median values will be stable even for users who travel occasionally.

The user's “frequently traveled” locations may also be determined. When the user is within one of the frequently traveled locations, it may be assumed that the user is familiar with the surrounding area. The frequently traveled locations may include, for example, the user's location of work. In order to reduce the processing power and maximize processing efficiency, raw latitude and longitude values may be rounded to two decimal points when determining location information. This reduces the distance resolution to approximately one mile. Second, the rounded latitude and longitude values at the current time (time=t) are compared with the rounded latitude and longitude values at the previous time (time=t−1). When a change in the rounded values is detected (e.g., from 33.40/−112.00 to 33.41/−112.01), the current rounded latitude and longitude values are stored in a memory. When no change is detected (e.g., from 33.40/−112.00 to 33.40/−112.00), the current rounded latitude and longitude values are discarded. With this method, one pair of latitude and longitude values will be stored for one trip to a particular location. Third, a histogram of rounded latitude and longitude pairs may be plotted over a running K number of days (e.g., 30 days). A location with a particular threshold frequency (e.g., 10) is considered as a location that the users frequently travel to. If the user travels again to this familiar location in the future, the user will not need navigation directions.

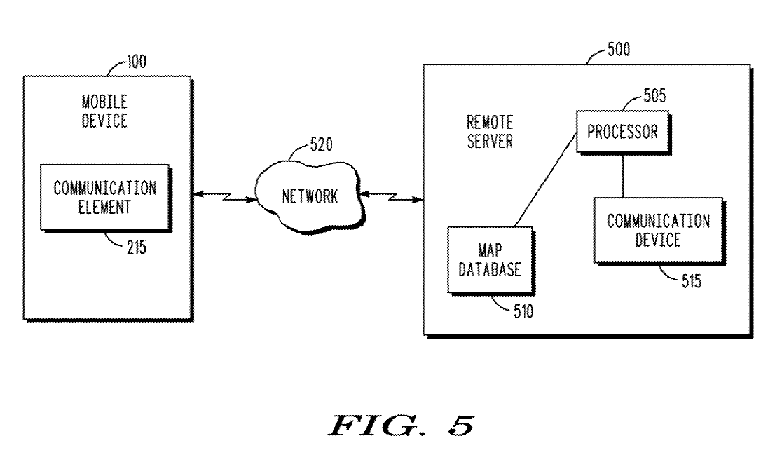

FIG. 5 illustrates a system for communication between a mobile device 100 and a remote server 500 according to at least one embodiment of the invention. As shown, the mobile device 100 includes a communication element 215. For the sake of simplicity, only the communication element 215 of the mobile device 100 is shown in FIG. 5. However, it should be appreciated that other components, such as those shown in FIG. 2, may also be included within the mobile device 100.

The remote server 500 may include a processor 505, a map database 510, and a communication device 515. The remote server 500 may determine the navigation directions to be sent to the user based on mapping information stored in the database. For example, the user's end location and current location may be transmitted from the mobile device 100 to the remote server 500. The remote server 500 may, in turn, access the map database 510 to determine the navigation directions and then the navigation directions are provided from the remote server 500 to the mobile device 100 via the communication device 515.

The system and method described herein provides a way of providing and prioritizing navigation directions to a mobile device such that the user will not be disturbed while engaged in a conversation on the mobile device when within a familiar area. There are numerous advantages to this approach. When the user is driving near his/her home or at a “frequently traveled” location and navigation directions are not always necessary for getting from location A to location B, the telephony function has a higher priority than the navigation function. In this case, voice navigation messages are not be delivered to users who are conversing on the telephone to minimize any possible disruptions to the ongoing conversation and user annoyance.

When a user is traveling at an unfamiliar location away from home and navigation directions are necessary for getting from location A to location B, the navigation function has a higher priority than the telephony function. In this case, voice navigation messages along with visual icons and text messages are delivered to users who are also conversing on the telephone to guide them to their destination. The phone conversation is muted in one embodiment and will not be muted in another embodiment.

This context-based modification of delivering navigation directions maximizes the effectiveness and user acceptance of navigation and telephony functions. Ultimately, this will enhance user experience and minimize functional conflicts and user annoyance.

Teachings discussed herein are directed to a method. A current location of a mobile device of a mobile subscriber is determined. Navigation directions from the current location to a designated destination are determined. A determination is made as to whether the current location is within a predetermined familiar area. Delivery of the navigation directions to the mobile device are prioritized in response to the mobile subscriber being engaged in a communication via the mobile device at a time that the navigation directions are determined. Only a first type of the navigation directions are provided when the current location being within the predetermined familiar area. At least a second type of navigation directions, different from the first type, are provided when the current location being outside of the predetermined familiar area.

The communication may be an audible conversation via the mobile device. The first type of navigation directions may comprise visual navigation directions. The visual navigation directions may comprise at least one of visual icons and text messages displayed on a display of the mobile device. The second type of navigation directions may include audible navigation directions and visual navigation directions. The communication of the mobile subscriber may be muted while the audible navigation directions are provided.

The current location may be determined based on Global Positioning System GPS coordinates. The predetermined familiar area is determined based on detected location information for the mobile subscriber during a predetermined time period. The predetermined familiar area may be determined based on detected location information for the mobile device over a designated time interval.

The teachings discussed herein are also directed to a system is provided that includes a location determination element to determine a current location of a mobile device of a mobile subscriber. A map database stores mapping information. At least one processor (a) determines navigation directions from the current location to a destination location based on the mapping information; (b) determines whether the current location is within a predetermined familiar area; and (c) prioritizes delivery of the navigation directions to the mobile device in response to the mobile subscriber being engaged in a communication via the mobile device at a time that the navigation directions are determined. Only a first type of the navigation directions are provided when the current location is within the predetermined familiar area. At least a second type of navigation directions, different from the first type, are provided when the current location is outside of the predetermined familiar area.

The teachings discussed herein are further directed to a navigation device. The navigation device may include a communication element to receive a current location of a mobile subscriber of a mobile device from a location determination device, and a destination location for the mobile subscriber. At least one processor is provided to (a) determine navigation directions from the current location to the destination location; (b) determine whether the current location is within a predetermined familiar area; and (c) prioritize delivery of the navigation directions to the mobile subscriber in response to the mobile subscriber being engaged in a communication via the mobile device at a time that the navigation directions are determined. Only a first type of the navigation directions are provided when the current location is within the predetermined familiar area. At least a second type of navigation directions, different from the first type, are provided when the current location is outside of the predetermined familiar area.

The navigation device may be housed within the mobile device or within a remote server in communication with the mobile device.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method, comprising:
determining a current location of a mobile device of a mobile subscriber;
determining navigation directions from the current location to a designated destination;
determining whether the current location is within a predetermined familiar area; and
prioritizing delivery of the navigation directions to the mobile device in response to the mobile subscriber being engaged in a communication via the mobile device at a time that the navigation directions are determined, wherein
in response to the current location being within the predetermined familiar area, only a first type of the navigation directions are provided; and
in response to the current location being outside of the predetermined familiar area, at least a second type of navigation directions, different from the first type, are provided.

2. The method of claim 1, wherein the communication is an audible conversation via the mobile device.

3. The method of claim 1, wherein the first type of navigation directions comprises visual navigation directions.

4. The method of claim 3, wherein the visual navigation directions comprise at least one of visual icons and text messages displayed on a display of the mobile device.

5. The method of claim 1, wherein the second type of navigation directions comprises
audible navigation directions and visual navigation directions.

6. The method of claim 5, wherein the communication of the mobile subscriber is muted while the audible navigation directions are provided.

7. The method of claim 1, wherein the current location is determined based on Global Positioning System (“GPS”) coordinates.

8. The method of claim 1, wherein the predetermined familiar area is determined based on detected location information for the mobile subscriber during a predetermined time period.

9. The method of claim 1, wherein the predetermined familiar area is determined based on detected location information for the mobile device over a designated time interval.

10. A system, comprising:
a location determination element to determine a current location of a mobile device of a mobile subscriber;
a map database to store mapping information;
at least one processor to
determine navigation directions from the current location to a destination location based on the mapping information;
determine whether the current location is within a predetermined familiar area; and
prioritize delivery of the navigation directions to the mobile device in response to the mobile subscriber being engaged in a communication via the mobile device at a time that the navigation directions are determined, wherein
in response to the current location being within the predetermined familiar area, only a first type of the navigation directions are provided; and
in response to the current location being outside of the predetermined familiar area, at least a second type of navigation directions, different from the first type, are provided.

11. The system of claim 10, wherein the first type of navigation directions comprise at least one of visual icons and text messages and the mobile device comprises a display to display the first type of navigation directions.

12. The system of claim 10, wherein the second type of navigation directions comprises
audible navigation directions and visual navigation directions, and the mobile device comprises a display to display the first type of navigation directions and a speaker to provide the audible navigation directions.

13. The system of claim 10, wherein the location determination element is adapted to determine Global Positioning System (“GPS”) coordinates.

14. A navigation device, comprising:
a communication element to receive
a current location of a mobile subscriber of a mobile device from a location determination device, and
a destination location for the mobile subscriber;
at least one processor to
determine navigation directions from the current location to the destination location;
determine whether the current location is within a predetermined familiar area; and
prioritize delivery of the navigation directions to the mobile subscriber in response to the mobile subscriber being engaged in a communication via the mobile device at a time that the navigation directions are determined, wherein
in response to the current location being within the predetermined familiar area, only a first type of the navigation directions are provided; and
in response to the current location being outside of the predetermined familiar area, at least a second type of navigation directions, different from the first type, are provided.

15. The navigation device of claim 14, wherein the navigation device is housed within the mobile device.

16. The navigation device of claim 14, wherein the navigation device is housed within a remote server in communication with the mobile device.
